(19) United States
(12) Patent Application Publication
(10) Pub. No.: US 2013/0333570 A1
(43) Pub. Date: Dec. 19, 2013

(54) Mobile apparatus for filtering air

(71) Applicant: deconta GmbH, Isselburg (DE)

(72) Inventors: Peter Kamperschroer, Wesel (DE); Martin Hemming, Wesel (DE)

(73) Assignee: deconta GmbH, Isselburg (DE)

(21) Appl. No.: 13/904,114

(22) Filed: May 29, 2013

(30) Foreign Application Priority Data
May 30, 2012 (DE) 10 2012 010 688.2
Jan. 18, 2013 (DE) 10 2013 100 507.1

(51) Int. Cl. B01D 46/00

(52) U.S. Cl. CPC B01D 46/0027
USPC 96/108; 55/471

(57) ABSTRACT

Mobile apparatus (1) for filtering air, having a housing (2) which has a front side (4) with an installed surface filter (3) and a fan (5) within the housing (2). A window (12) which covers the intake region of the surface filter (3) parallel to the flow is connected or can be connected to the housing (2), through which window (12) operations which happen or are carried out in the intake region can be observed. The window is preferably connected pivotably to the housing (2) in the form of a cover.

The invention relates to a mobile apparatus for filtering air, having a housing which has a front side of laminar design, into which a surface filter is installed, and having a fan within the housing, which fan generates a flow of unfiltered air through the surface filter and blows it out filtered through an outlet opening which is situated at another location of the housing.

An apparatus of this type is known from U.S. Pat. No. 3,523,409 A. Both main sides of the rectangular housing are open and are fitted over the entire surface area with removable filter plates. An electrically driven extractor is installed into the housing, which extractor sucks air in through the filter plates and blows it out via an opening in the top side of the housing. The unit is supposed to be capable of being carried from one room to another within a building, with the result that, in particular, the dust portion present there in the ambient air can be collected. Odour elimination is not mentioned expressly.

A portable apparatus for filtering air (U.S. Pat. No. 3,861,894 A) is known, by way of which a zone with pure air can be produced by processing and filtering of air. Here, both solid particles and bad odours and gases are to be separated from the air to be filtered.

Both abovementioned units are quasi portable apparatuses which suck in ambient air as units and discharge it in a filtered manner. In some manipulations which are carried out by people, odour and dust sources are produced, however, which can occur in the immediate vicinity of the person performing the action. The following are to be mentioned as an example of this:
changing the stoma pouch (stoma=ostomy; extreme odour nuisance as a result of fermenting intestinal contents);
soldering and low-melting-temperature solder with the development of fumes;
onion and garlic skinning.

The object is set for the invention of specifying a portable apparatus for filtering ambient air, which portable apparatus makes undisrupted observing of the work possible in the case of operations of this type.

This object is achieved in a mobile apparatus in accordance with the type which is stated at the outset, in which a window which covers the intake region of the surface filter parallel to the flow is connected or can be connected to the housing, through which window operations which occur or are carried out in the intake region can be observed.

In particular, the cover which can be moved or attached plays an essential role here, since it can both enclose the area, from which the air is extracted, and also substantially simplifies the observation process.

The window is preferably connected pivotably to the housing in the form of a cover, a hinge for pivoting the window preferably being attached to the upper side of the housing.

In order to increase the stability, it is proposed that the cover comprises a framed, transparent pane. The said pane can also be configured as a magnifying glass on part of its transparent surface, it being possible for a simple form of the magnifying glass to be a Fresnel lens.

The cover is preferably provided with a rigid apron or a flexible curtain on the side, at least on one of its free edges.

The work is facilitated if an illumination apparatus is attached to the housing and/or to the window.

The surface filter on the front side of the apparatus can be an odour filter, in particular an activated charcoal filter, but can also be a combined particle and odour filter.

The outlet opening for the filtered air flow is preferably situated in a housing side which is arranged opposite the front side.

The surface filter is held removably in a guide as a plate-like element, in order to make rapid replacement possible.

The fan is preferably driven by an electric motor which is fed by a battery which is situated within the housing. Instead of this arrangement, however, an external power source can also be used.

In order to hold the apparatus in the region of the working area without special effort, the said apparatus can be provided with a carrying belt or can be connected to a stand, it also being possible for the latter to in turn be movable.

One exemplary embodiment of the invention is shown in the drawing, in which, in detail:

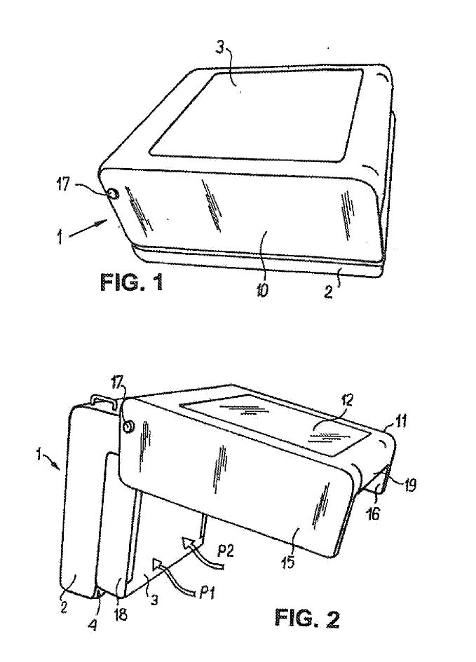

FIG. 1 shows a mobile apparatus for filtering air, in perspective and viewed from the side,

FIG. 2 shows the apparatus according to FIG. 1 with a cover which is folded open, in the working position,

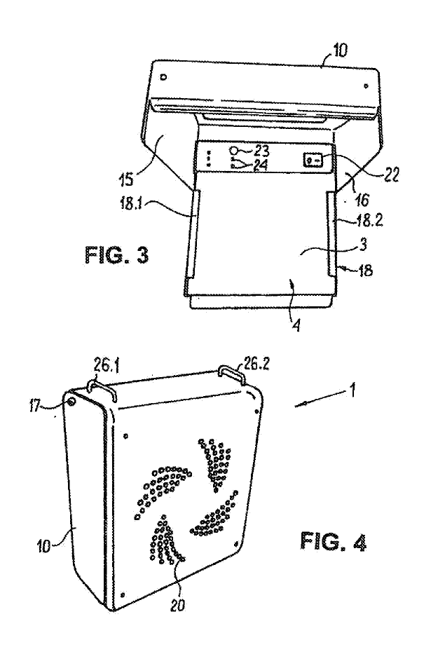

FIG. 3 shows the apparatus in the position according to FIG. 2, with a view of the surface filter,

FIG. 4 shows the apparatus according to FIG. 1, as viewed from the rear side,

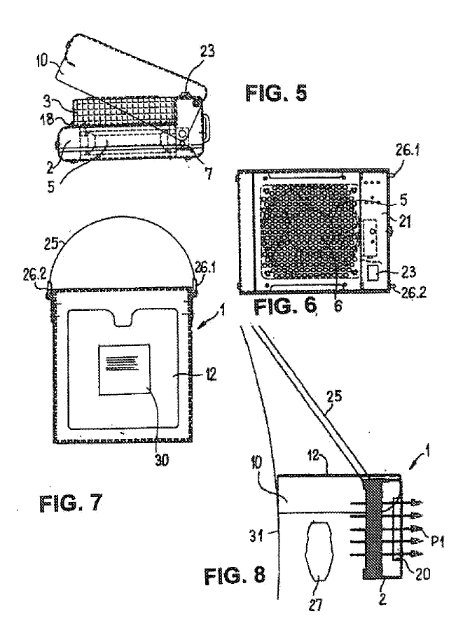

FIG. 5 shows a diagrammatic illustration of the apparatus, as viewed from the side,

FIG. 6 shows a view of the intake side of the housing,

FIG. 7 shows an embodiment with a carrying belt, and

FIG. 8 shows a diagrammatic example of the use of the apparatus when changing a stoma pouch.

FIGS. 1 to 4 show an apparatus 1 for filtering air, the dimensions and weight of which apparatus 1 are such that it can be carried, in particular, from activity area to activity area, but can also be held on a carrying belt in front of the body of a person.

The apparatus 1 has a rectangular housing 2 which is of L-shaped design in side view in the state in which it is ready for use, the long limb of the L carrying a surface filter 3 in front of the front side 4 of laminar design. A fan wheel 5 (cf. FIGS. 5 and 6) which is driven by an electric motor 6 which is arranged in the hub of the fan wheel 5 is situated within the housing 2 and behind the surface filter 3. The said electric motor 6 receives its energy via a battery 7.

An essential part of the apparatus 1 is a cover 10 which can be folded open in relation to the housing 2 (cf. FIG. 2) by approximately 90° in comparison with its closed state (cf. FIG. 1). The cover 10, the design of which can be seen, in particular, from FIGS. 2 and 3, has a cover upper side 11 which has a frame-like design and has a rectangular opening, in which a transparent pane 12 of silicate or polymer glass is held. A magnifying glass 30, a colour filter or the like can also be attached within the pane region, that is to say at least on part of the transparent area. The magnifying glass 30 is preferably a Fresnel lens (cf. FIG. 7).

Accordingly, the pane 12 permits a view of the intake region 13 of the apparatus, with the result that operations in the intake region 13 can be observed. The frame part 14 which holds the pane 12 is continued laterally by two rigid aprons 15, 16 which stand perpendicularly with respect to the frame part 14. In the folded state of the cover 10, the aprons 15, 16 cover the side of the housing. The housing 2 is also provided on the short L-limb on its two sides with a pivot 17, here in each case one threaded bolt, which pivot 17 is connected to in each case one apron 15, 16 at its filter-side end and thus makes the pivoting of the cover possible.

In addition, latching apparatuses (not shown) are also provided which prevent unintentional adjustment of the closed or open cover 10. Lying opposite the hinge, the aprons are connected by a front tab 19 which runs parallel to the front side 4 and is bent out of the frame part 14.

If desired, the cover can also be designed such that it can be attached as a cap, instead of the said cover being held on hinges.

The surface filter 3 comprises an activated charcoal mass which is approximately 30 mm thick, is interspersed with fibres and has a rectangular design.

The surface filter 3 serves primarily as an odour filter. However, other filter substances can also be used, for examples those which collect particles such as dust particles or those which are particle and odour filters at the same time.

In order for it to be possible to exchange respective surface filters 3 simply after the filter capacity thereof is exhausted, a guide 18 which comprises two metal cheeks 18.1, 18.2 is provided in front of the housing 2, in which guide 18 the surface filter 3 is held such that it can be removed and displaced.

In the exemplary embodiment, the housing 2, the cover 10 and the aprons 15, 16 with front tab 14 are composed of coated aluminium sheet. However, other metals and alloys, for example duralumin, and plastics can also be used. Instead of metal aprons, for example, flexible textile or film materials can also be used. It appears to be essential that an air flow which is as dense and concentrated as possible (cf. arrows P1, P2) is to be produced, with the result that all non-desirable particles and gas portions are drawn off through the surface filter 3 in the intake region 13.

It can be seen from FIGS. 5 and 6 in a diagrammatic view that the fan wheel 5 is arranged immediately behind the surface filter 3. The filtered air is guided through the housing 2 and is blown out through outlet openings 20 which are situated on the rear side 21 of the housing 2.

If the front side 4 is viewed below the cover 10 according to FIG. 3, it can be seen that the short L-limb of the housing 2 is equipped on its end side 21 with a number of operating elements (cf. also FIG. 6). The electric motor 6 can be switched by means of an on/off switch 22. Various control lamps 24 show the charging state, filter change and the like. An LED illumination body 23 illuminates the observation basket below the pane 12. Further illumination bodies (not shown) can also be attached to the underside of the cover 10 or to the inner side of the apron.

In order for it to be possible to carry the apparatus 1 on a person's body, a carrying belt 25 is provided which is connected to the housing via two eyes 26.1, 26.2. Instead of a carrying belt, the apparatus can also be suspended on a movable frame or stand, in a similar manner as is used to suspend transfusion vessels in hospitals.

FIG. 8 shows one example of use of the apparatus 1. The apparatus 1 which is folded open is suspended on the carrying belt 25. The cover 10 is supported against the abdominal wall 31 of a patient who is changing a stoma pouch 27, the odour which is produced in the process being unpleasant. The gases (P1) which are present within the area of activity are extracted through the surface filter 3 and are purified in the surface filter 3.

Similar examples of use are stated at the outset, in particular soldering work which causes particulate matter, observations of chemical reactions and the like.

The external shape of the housing 2 which is shown here as a rectangular shape can be adapted to the corresponding areas of activity, for example can have a curve which is adapted to the human body.

1. Mobile apparatus (1) for filtering air, having a housing (2) which has a front side (4) of laminar design, into which a surface filter (3) is installed, and having a fan (5) within the housing (2), which fan (5) generates a flow of unfiltered air through the surface filter (3) and blows it out filtered through an outlet opening (20) which is situated at another location of the housing, characterized in that a window (12) which covers the intake region of the surface filter (3) parallel to the flow is connected or can be connected to the housing (2), through which window (12) operations which occur or are carried out in the intake region can be observed.

2. Mobile apparatus according to claim 1, characterized in that the window is connected pivotably to the housing in the form of a cover (10).

3. Mobile apparatus according to claim 2, characterized in that a hinge for pivoting the window is attached to the upper side of the housing (2).

4. Mobile apparatus according to claim 2, characterized in that the cover comprises a framed, transparent pane (12).

5. Mobile apparatus according to claim 1, characterized in that the pane (12) is configured as a magnifying glass (30) at least on part of its transparent surface.

6. Mobile apparatus according to claim 5, characterized in that the pane (12) is configured as a magnifying glass (30) in the form of a Fresnel lens at least on part of its transparent surface.

7. Mobile apparatus according to claim 1, characterized in that the cover carries a rigid apron (15) or a flexible curtain at least on one of its free edges.

8. Mobile apparatus according to claim 1, characterized in that an illumination apparatus (23) is installed on the housing and/or on the window.

9. Mobile apparatus according to claim 1, characterized in that the surface filter (3) on the front flat side of the apparatus is an odour filter, in particular an activated charcoal filter.

10. Mobile apparatus according to claim 1, characterized in that the surface filter (3) is a particle and odour filter.

11. Mobile apparatus according to claim 1, characterized in that the outlet opening (20) for the filtered air flow is situated in a housing side which is arranged opposite the front side.

12. Mobile apparatus according to claim 1, characterized in that the surface filter is held removably in a guide (18) as a plate-like element.

13. Mobile apparatus according to claim 1, characterized in that the fan is driven by an electric motor (6).

14. Mobile apparatus according to claim 13, characterized in that the electric motor is fed by a battery (7) which is situated in the housing.

15. Mobile apparatus according to claim 1, characterized in that the apparatus is provided with a carrying belt (25).

16. Mobile apparatus according to claim 1, characterized in that the apparatus is connected to a stand.

17. Mobile apparatus according to claim 16, characterized in that the stand is movable.
